(19) United States
(12) Patent Application Publication
(10) Pub. No.: US 2025/0237778 A1
(43) Pub. Date: Jul. 24, 2025

(54) CEMENT EVALUATION AND CASING ECCENTRICITY DETECTION WITH CBL IN NON-CONCENTRIC CASING STRING WITH NARROW ANNULUS

(71) Applicant: Baker Hughes Oilfield Operations LLC, Houston, TX (US)

(72) Inventors: Baoyan Li, Tomball, TX (US); Jose Mauricio Garcia Roman, Magnolia, TX (US); Joseph Olaiya, Houston, TX (US)

(73) Assignee: Baker Hughes Oilfield Operations LLC, Houston, TX (US)

(21) Appl. No.: 18/417,528

(22) Filed: Jan. 19, 2024

(51) Int. Cl. G01V 1/50; E21B 47/005

(52) U.S. Cl. CPC G01V 1/50; E21B 47/005

(57) ABSTRACT

Disclosed herein is a workflow for evaluating the cement between a casing string and the surrounding formation in a wellbore and for determining casing string eccentricity using sector cement bond log (CBL) data. This method involved using a cement bond logging tool with an extended acquisition time window to capture multiple interface echoes. From this sector CBL data, a data matrix of waveform information is generated, with each row representing waveform data from different azimuthal sectors. Through singular value decomposition, the principal components of the matrix are identified. Subsequent component analysis emphasizes significant components of waveforms. The significant waveform components are then used to model waveforms using local cluster modeling. The method proceeds by analyzing decomposed data to pinpoint cement zones, compute an eccentricity index for casing deviation, and detect cement channels.

### TECHNICAL FIELD

This disclosure relates to the field of hydrocarbon exploration and production, specifically to improved workflows for generating cement bond logs and the interpretation of those logs for evaluation of cement bonds and the detection of casing eccentricity, even in non-concentric casing strings with a narrow annular spacing.

### BACKGROUND

In the exploration and production of hydrocarbons, wells are placed to access subsurface hydrocarbon formations beneath the surface of the earth. Once drilling of a wellbore in the subsurface hydrocarbon formation is complete, the wellbore is typically lined with steel casing to provide support and provide for the integrity of the well. After casing is in place, cement is pumped into the annular space between the casing and the formation to bond the casing to the wellbore. This cementing process serves a variety of purposes, including providing mechanical support to the casing, protecting the casing from corrosion by isolating it from corrosive formation fluids, and isolating different zones within the formation to prevent the intermixing of fluids from different zones.

Therefore, for the continued production of hydrocarbons, a proper bond is desired between the cement and the casing, as well as between the cement and the formation. Poor cement bonding can lead to a variety of problems. For example, if the cement bond is poor, fluids can leak behind the casing, which can lead to corrosion, casing failure, and environmental damage. As another example, a poor cement bond can allow for the flow of fluids between different isolation zones, which is undesirable as it may lead to the mixing of water with oil and gas and may lead to problems when abandoning a well.

Given these potential issues that may result from poor cement bonds, evaluating the quality of such cement bonds is of particular interest.

A commonly used type of tool for evaluating the quality of cement bonds is a Cement Bond Logging (CBL) tool. This tool includes a transmitter that emits a sonic signal (e.g., acoustic waves) and one or more receivers that detect this signal after it has passed through the casing, cement, and formation. From the received signal, a cement map or log can be generated. This cement log aids in identifying the highest point of cement placement, known as the cement top, and in identifying and locating voids or pathways in the cement layer bonding the casing to the formation, referred to as cement channels.

However, conventional workflows used to interpret these cement maps or logs, derived from the CBL tool logging data, have inherent limitations. A metric from this data, the amplitude of the first E1 positive peak of waveform, is of particular interest. This waveform peak is the first arrival of the acoustic wave at the receiver after passing through the casing. The amplitude of this waveform peak can offer insights into cement bond quality. However, this amplitude can be influenced by various factors. These factors include the size, thickness, and weight of the casing, the distance between the transmitter and receiver, the composition of the cement, mud presence inside the casing, eccentricity of the casing in the wellbore, and the annular spacing, which is the gap between two casing strings or between a casing and the surrounding formation. The influences of these factors means that traditional cement logs may possess interpretative uncertainties. These uncertainties are magnified in deviated wells, those not adhering to a strictly vertical trajectory, especially when the annular spacing is less than 1 inch.

Given this, a need remains for improved techniques for obtaining cement logs that mitigate the aforementioned uncertainties.

### SUMMARY

Disclosed herein is a method for evaluating cement between a casing string in a wellbore and material surrounding the casing string, and for detecting eccentricity of the casing string, using sector cement bond log (CBL) data. The method includes steps of: a) using a cement bond logging tool to capture sector CBL data with an extended acquisition time window, the extended acquisition time window being sufficiently long to permit logging of multiple interface echoes, each interface echo indicating an acoustic reflection generated when an acoustic wave emitted by the cement bond logging tool encounters an interface between different materials; b) setting a depth range and initializing a depth counter; and c) from the sector CBL data, generating a data matrix of waveform data from the CBL data at the depth specified by the depth counter, where each row of the matrix represents waveform data collected by the cement bond logging tool from different azimuthal sectors.

The method further includes steps of: d) performing singular value decomposition on the data matrix to derive its constituent components; e) conducting component analysis to filter out noise and identify significant waveform components; f) generating a local cluster model of the waveform data at the depth specified by the depth counter as a combination of the identified significant components, using local cluster modeling; and g) applying the local cluster model to the waveform data, thereby producing a modeled waveform represented as a combination of its identified significant components.

The method additionally includes steps of: h) if the depth counter is less than an end of the depth range, increment the depth counter and return to step c), otherwise proceed to step i); i) identifying cement zones based on amplitudes of first E1 peaks of modeled waveforms reflected by the interface between the casing string and the cement, for each azimuthal sector; j) calculating an eccentricity index, for each sector, representing deviation of the casing string from its ideal position; and k) detecting cement channels based on deviations in a first component of the modeled waveform at each depth and azimuthal sector.

The method may include, from the cement zones, identifying free pipe zones, wherein the free pipe zones are depth zones in which cement is not present.

The eccentricity index may be calculated for each depth point.

The extended acquisition time window may have a time duration of between 700 μs and 800 μs.

The extended acquisition time window may be sufficiently long to permit logging of first, second, and third interface echoes, the first interface echo being between the cement bond logging tool and the casing, the second interface echo being between the casing and the cement, the third interface echo being between casing annulus filling material and a formation into which the wellbore is drilled.

The data matrix may be:

$${X}_{{m}_{c}} = [ \begin{matrix}{x}_{{m}_{c , 1} ( {t}_{1} )} & … & {x}_{{m}_{c , 1} ( {t}_{{N}_{t}} )} \\ ⋮ & ⋱ & ⋮ \\ {x}_{{m}_{c} , {N}_{s} ( {t}_{1} )} & … & {x}_{{m}_{c} , {N}_{s} ( {t}_{{N}_{t}} )}\end{matrix} ] = [ \begin{matrix}{x}_{{m}_{C} , 1} \\ ⋮ \\ {x}_{{m}_{C} , {N}_{s}}\end{matrix} ]$$

wherein xₘ_{_{C}}_{,i}, i=1, 2, . . . , Nₛ is the waveform data acquired by the cement bond logging tool at ith azimuthal sector and a m_{C}th depth point, wherein the depth range is [mₛ, mₑ], and wherein the depth counter is initialized to m_{C}=mₛ.

The singular value decomposition may be performed as: Xₘ_{_{C}}=Uₘ_{_{C}}Sₘ_{_{C}}Vₘ_{_{C}}^{T}
where T denotes a transpose operation, where Uₘ_{_{C}} is a left singular matrix containing eigenvectors of Xₘ_{_{C}}Xₘ_{_{C}}^{T}, where Vₘ_{_{C}} is a right singular matrix containing eigenvectors of Xₘ_{_{C}}^{T}Xₘ_{_{C}}, where Sₘ_{_{C}} is a singular value diagonal matrix, with its values being derived from the eigenvalues of Xₘ_{_{C}}Xₘ_{_{C}}^{T}, with Sₘ_{_{C}} being

$${S}_{{m}_{C}} = [ \begin{matrix}{σ}_{{m}_{C} , 1} & 0 & 0 & 0 \\ 0 & {σ}_{{m}_{C} , 2} & 0 & 0 \\ 0 & 0 & ⋱ & 0 \\ 0 & 0 & 0 & {σ}_{{m}_{C} , {N}_{s}}\end{matrix} ] ,$$

where σₘ_{_{C}}_{, 1}, σₘ_{_{C}}_{,2}, . . . , σₘ_{_{C}}_{,N}_{ₛ} are the singular values of the singular value diagonal matrix, which are non-negative and ordered such that σₘ_{_{C}}_{,1}>σₘ_{_{C}}_{,2}> . . . >σₘ_{_{C}}_{,N}_{ₛ}, with Nₛ representing a total number of the azimuthal sectors.

The identification of the significant waveform components may be performed by identifying a set of r components that satisfy

$$\frac{{σ}_{{m}_{C} , j}}{{σ}_{{m}_{C} , j + 1}} > ε ,$$

with σₘ_{_{C}}_{,j} and σₘ_{_{C}}_{,j+1} being consecutive singular values derived from the singular value decomposition, and with E being a predefined threshold.

The local cluster model of the waveform data generated at step f) may be generated as:

$${X}_{{m}_{C}} = {A}_{{m}_{C}} {V}_{{m}_{C} , {r}_{{m}_{C}}}^{T}$$

where Aₘ_{_{C}} is a matrix capturing weight or score of each feature component vₘ_{_{C}}_{,k} of waveform for every azimuthal sector, represented as:

$${A}_{{m}_{C}} = [ \begin{matrix}{a}_{1 , 1}^{{m}_{C}} & {a}_{1 , 2}^{{m}_{C}} & … & {a}_{1 , {r}_{{m}_{C}}}^{{m}_{C}} \\ {a}_{2 , 1}^{{m}_{C}} & {a}_{2 , 2}^{{m}_{C}} & … & {a}_{2 , {r}_{{m}_{C}}}^{{m}_{C}} \\ ⋮ & ⋮ & ⋱ & ⋮ \\ {a}_{{N}_{s} , 1}^{{m}_{C}} & {a}_{{N}_{s} , 2}^{{m}_{C}} & … & {a}_{{N}_{s} , {r}_{{m}_{C}}}^{{m}_{C}}\end{matrix} ] = [ \begin{matrix}{a}_{{m}_{C} , 1} \\ {a}_{{m}_{C} , 2} \\ ⋮ \\ {a}_{{m}_{C} , {N}_{s}}\end{matrix} ]$$

with each value a_{i,j}^{m}^{_{C}} quantifying contribution of a jth independent component from the set of r components to the waveform data at the ith azimuthal sector at the depth point m_{C}, and with aₘ_{_{C}}_{,i} being a row vector representing amplitude scores of the independent components to the waveform of the ith azimuthal sector at the depth point m_{C}.

The application of the local cluster model to the waveform data at step g) may be performed as a decomposition represented by:

$${x}_{{m}_{C} , i} = {a}_{{m}_{C} , i} {V}_{{m}_{C} , {r}_{{m}_{C}}}^{T} = {\sum }_{k = 1}^{{r}_{{m}_{C}}} {a}_{i , k}^{{m}_{C}} {v}_{{m}_{C} , k}^{T} = {\sum }_{k = 1}^{{r}_{{m}_{C}}} {x}_{{m}_{C} , i , k}$$

with a least squared error method then being used to calculate each row vector aₘ_{_{C}}_{,i} as the solution of

$${a}_{{m}_{C} , i} {V}_{{m}_{C} , {r}_{{m}_{C}}}^{T} = {x}_{{m}_{C} , i} .$$

The eccentricity index may be calculated at each depth as:

$${e}_{{m}_{C} , i} = \frac{{a}_{i , 2}^{{m}_{C}}}{{a}_{i , 1}^{{m}_{C}}} .$$

Also disclosed herein is a system for evaluating cement between a casing string in a wellbore and material surrounding the casing string, and for detecting eccentricity of the casing string. The system includes a cement bond logging tool configured to capture sector CBL data with an extended acquisition time window, the extended acquisition time window being sufficiently long to permit logging of multiple interface echoes, each interface echo indicating an acoustic reflection generated when an acoustic wave emitted by the cement bond logging tool encounters an interface between different materials. Processing circuitry associated with the cement bond logging tool is configured to perform steps of: a) setting a depth range and initializing a depth counter; b) from the sector CBL data, generating a data matrix of waveform data from the CBL data at the depth specified by the depth counter, where each row of the matrix represents waveform data collected by the cement bond logging tool from different azimuthal sectors; c) performing singular value decomposition on the data matrix to derive its constituent components; d) conducting component analysis to filter out noise and identify significant waveform components; e) generating a local cluster model of the waveform data at the depth specified by the depth counter as a combination of the identified significant components, using local cluster modeling.

The processing circuitry may be further configured to perform steps of: f) applying the local cluster model to the waveform data, thereby producing a modeled waveform represented as a combination of its identified significant components; g) if the depth counter is less than an end of the depth range, increment the depth counter and return to step b), otherwise proceed to step h); h) identifying cement zones based on amplitudes of first E1 peaks of modeled waveforms reflected by the interface between the casing string and the cement, for each azimuthal sector; i) calculating an eccentricity index, for each sector, representing deviation of the casing string from its ideal position; and j) detecting cement channels based on deviations in a first component of the modeled waveform at each depth and azimuthal sector.

The processing circuitry may include a controller within the cement bond logging tool and/or may include an uphole data processing system.

The extended acquisition time window may be sufficiently long to permit logging of first, second, and third interface echoes, the first interface echo being between the cement bond logging tool and the casing, the second interface echo being between the casing and the cement, the third interface echo being between casing annulus filling material and a formation into which the wellbore is drilled.

The data matrix may be

$${X}_{{m}_{c}} = [ \begin{matrix}{x}_{{m}_{c , 1} ( {t}_{1} )} & … & {x}_{{m}_{c , 1} ( {t}_{{N}_{t}} )} \\ ⋮ & ⋱ & ⋮ \\ {x}_{{m}_{c} , {N}_{s} ( {t}_{1} )} & … & {x}_{{m}_{c} , {N}_{s} ( {t}_{{N}_{t}} )}\end{matrix} ] = [ \begin{matrix}{x}_{{m}_{C} , 1} \\ ⋮ \\ {x}_{{m}_{C} , {N}_{s}}\end{matrix} ]$$

wherein x_{c,i}, i=1, 2, . . . , Nₛ is the waveform data acquired by the cement bond logging tool at ith azimuthal sector and a m_{C}th depth point, wherein the depth range is [mₛ, mₑ], and wherein the depth counter is initialized to m_{C}=mₛ.

The singular value decomposition may be performed by the processing circuitry as: Xₘ_{_{C}}=Uₘ_{_{C}}Sₘ_{_{C}}Vₘ_{_{C}}^{T}
where T denotes a transpose operation, where Uₘ_{_{C}} is a left singular matrix containing eigenvectors of Xₘ_{_{C}}Xₘ_{_{C}}^{T}, where Vₘ_{_{C}} is a right singular matrix containing eigenvectors of Xₘ_{_{C}}^{T}Xₘ_{_{C}}, where Sₘ_{_{C}} is a singular value diagonal matrix, with its values being derived from the eigenvalues of Xₘ_{_{C}}Xₘ_{_{C}}^{T}, with Sₘ_{_{C}} being

$${S}_{{m}_{C}} = [ \begin{matrix}{σ}_{{m}_{C} , 1} & 0 & 0 & 0 \\ 0 & {σ}_{{m}_{C} , 2} & 0 & 0 \\ 0 & 0 & ⋱ & 0 \\ 0 & 0 & 0 & {σ}_{{m}_{C} , {N}_{s}}\end{matrix} ] ,$$

where σₘ_{_{C}}, σₘ_{_{C}}_{,2}, . . . , σₘ_{_{C}}_{,N}_{ₛ}
where σₘ_{_{C}}, σₘ_{_{C}}_{,2}, . . . , σₘ_{_{C}}_{,N}_{ₛ} are the singular values of the singular value diagonal matrix, which are non-negative and ordered such that σₘ_{_{C}}_{,1}>σₘ_{_{C}}_{,2}> . . . >σₘ_{_{C}}_{,N}_{ₛ}, with Nₛ representing a total number of the azimuthal sectors.

The identification of the significant waveform components may be performed by the processing circuitry as identifying a set of r components that satisfy

$$\frac{{σ}_{{m}_{C} , j}}{{σ}_{{m}_{C} , j + 1}} > ε ,$$

with σₘ_{_{C}}_{,j} and σₘ_{_{C}}_{,j+1} being consecutive singular values derived from the singular value decomposition, and with E being a predefined threshold.

The local cluster model of the waveform data generated by the processing circuitry at step e) may be generated as:

$${X}_{{m}_{C}} = {A}_{{m}_{C}} {V}_{{m}_{C} , {r}_{{m}_{C}}}^{T}$$

where Aₘ_{_{C}} is a matrix capturing weight or score of each feature component vₘ_{_{C}}_{,k}^{T} of waveform for every azimuthal sector, represented as:

$${A}_{{m}_{C}} = [ \begin{matrix}{a}_{1 , 1}^{{m}_{C}} & {a}_{1 , 2}^{{m}_{C}} & … & {a}_{1 , {r}_{{m}_{C}}}^{{m}_{C}} \\ {a}_{2 , 1}^{{m}_{C}} & {a}_{2 , 2}^{{m}_{C}} & … & {a}_{2 , {r}_{{m}_{C}}}^{{m}_{C}} \\ ⋮ & ⋮ & ⋱ & ⋮ \\ {a}_{{N}_{s} , 1}^{{m}_{C}} & {a}_{{N}_{s} , 2}^{{m}_{C}} & … & {a}_{{N}_{s} , {r}_{{m}_{C}}}^{{m}_{C}}\end{matrix} ] = [ \begin{matrix}{a}_{{m}_{C} , 1} \\ {a}_{{m}_{C} , 2} \\ ⋮ \\ {a}_{{m}_{C} , {N}_{s}}\end{matrix} ]$$

with each value a_{i,j}^{m}^{_{C}} quantifying contribution of a jth independent component from the set of r components to the waveform data at the ith azimuthal sector at the depth point m_{C}, and with aₘ_{_{C}}_{,i} representing scores of the independent components to the waveform of the ith azimuthal sector at the depth point m_{C}.

The application of the local cluster model to the waveform data by the processing circuitry at step f) may be performed as a decomposition represented by:

$${x}_{{m}_{C} , i} = {a}_{{m}_{C} , i} {V}_{{m}_{C} , {r}_{{m}_{C}}}^{T} = {\sum }_{k = 1}^{{r}_{{m}_{C}}} {a}_{i , k}^{{m}_{C}} {v}_{{m}_{C} , k}^{T} = {\sum }_{k = 1}^{{r}_{{m}_{C}}} {x}_{{m}_{C} , i , k}$$

with a least squared error method then being used to calculate the solution of:

$${a}_{{m}_{C} , i} \\ for : \\ {a}_{{m}_{C} , i} {V}_{{m}_{C} , {r}_{{m}_{C}}}^{T} = {x}_{{m}_{C} , i} ,$$

wherein the eccentricity index is calculated at each depth as:

$${e}_{{m}_{C} , i} = \frac{{a}_{i , 2}^{{m}_{C}}}{{a}_{i , 1}^{{m}_{C}}} .$$

### BRIEF DESCRIPTION OF THE DRAWINGS

FIG. 1 is a diagrammatical view of a wellsite with a casing system installed in the wellbore, with a cement bond logging tool being lowered into the wellbore via a wireline.

FIG. 2 is a flowchart of a first workflow disclosed herein, this workflow being performed on sector CBL log data.

FIG. 3 is a graph of example data showing the amplitudes of the modeled waveform over a range of depths, this waveform being obtained as per the workflow of FIG. 2.

FIG. 4 is a graph of example raw sonic waveform data collected during performance of the workflow of FIG. 2.

FIG. 5 a graph of example eccentricity index generated using the workflow of FIG. 2.

FIG. 6 is a graph of an example a score image of a feature component generated using the workflow of FIG. 2 over a range of depths.

FIG. 7A is a graph of an example of a score image of the first feature component generated using the workflow of FIG. 2 over a range of depths to perform channel identification.

FIG. 7B is a graph of another example of an absolute score image of the second feature component generated using the workflow of FIG. 2 over a range of depths to perform channel identification.

FIG. 8 is a graph of example raw sonic reflection waveform data collected from a first sector of the sector receiver array during performance of the workflow of FIG. 2.

FIG. 9 is a graph of example raw sonic waveform data collected from a fifth sector of the sector receiver array during performance of the workflow of FIG. 2.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

### A. General Description

Disclosed herein is a data analysis workflow aimed at enhancing the accuracy of identifying the cement top, identifying the presence of cement channels, and detecting casing eccentricity of a casing string, particularly a casing string with a narrow annular spacing.

For example, utilized in this workflow is an extended acquisition time window for the first E1 peak to avoid missing the reflected acoustic wave that may be related to annular spacing. Also, the workflow includes performing multiple component analyses of a subset of the acoustic waveforms to enable reliable identification of features linked with case bonding and annular spacing at each depth sampling point.

One advantage of the workflow is the minor extension required for the acquisition time window of an acquired waveform, which is on the order of a few hundred microseconds (extended to around 700 microseconds). This time window extension provides for an acquisition time window that enables capture of multiple interface echoes.

The term “echo” refers to the reflected acoustic wave that is detected after the original wave encounters an interface between different materials. Each interface will cause a reflection, and these reflections are detected as “echoes.” The first interface the acoustic wave encounters in a cased hole is the interface between the mud and the inside of the casing, and the reflection from this interface generates the first interface echo. After passing through the casing, the next major interface the acoustic wave encounters is between the casing and the cement (or the casing annulus filling material), and the reflection from this interface generates the second interface echo. After passing through the cement, the next major interface the acoustic wave encounters is between the casing annulus filling material and the surrounding formation, and the reflection from this interface generates the third interface echo.

The above time window extension provides for an acquisition time window that enable capture of the first, second, and third interface echoes. By capturing these echoes which can subsequently be analyzed, the workflow provides for insights into the types of materials present in the annulus and their acoustic properties. Indeed, this enhanced visibility allows for a detailed contrast of the acoustic impedance between the filling materials and the casing, which may permit detection of casing eccentricity within the casing string. This workflow is flexible, applicable to a variety of casing sizes, applicable to casing strings without constant casing sizes.

### B. Hardware Description

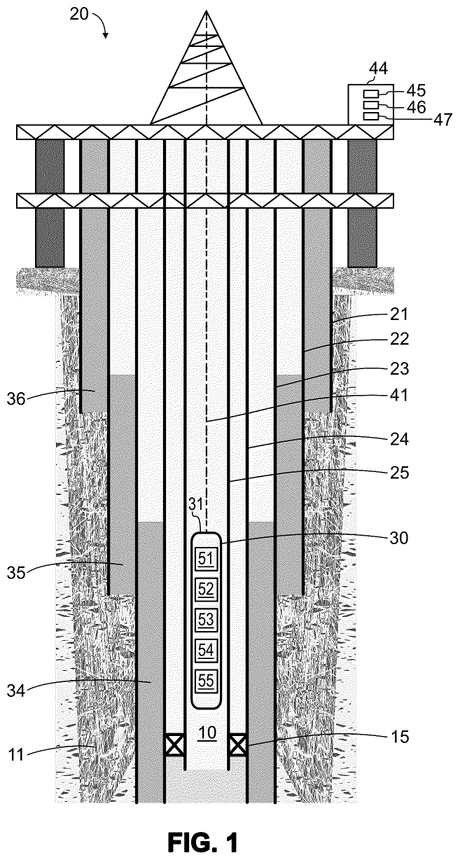

Shown in FIG. 1 is a cross-sectional view of a subsurface formation 11 having a wellbore 10 formed therein, with a casing system 20 installed within the wellbore 10. Since this disclosure focuses on cement used within the casing system 20, the casing system 20 will be described in the context of the process for installing the casing system. Drilling begins with the formation of a borehole 10 that extends from the surface into the subsurface formation 11. Then, the conductor casing 21 is installed, positioned in the uppermost section of the borehole 10 to provide stability to the shallow formations. Once the conductor casing 21 is in place, cement 36 is pumped down its interior, with the cement 36 then flowing back up the annular space between the conductor casing 21 and the borehole 10, anchoring the conductor casing 21 securely to the borehole wall. The surface casing 22 is then run, positioned concentrically inside the conductor casing 21 and extending deeper into the borehole 10. Cement 35 is then pumped down the interior of the surface casing 22, flowing back up the annular space between the surface casing 22 and the conductor casing 21, cementing the surface casing 22 in place to isolate potential water zones from the borehole 10. Following the cementation of the surface casing 22, the intermediate casing 23 is run. Positioned concentrically within the surface casing 22, the intermediate casing 23 is set to isolate certain zones within the subsurface formation 11. After positioning the intermediate casing 23 at the desired depth, cement 34 is pumped down its interior, with the cement 34 subsequently flowing back up, filling the annular space between the intermediate casing 23 and the surface casing 22, cementing the intermediate casing 23 in place. The production casing 24 is then run concentrically inside the intermediate casing 23 to the desired production depth within the subsurface formation 11. This casing remains uncemented in the depicted wellsite.

Inside the production casing 24, the production tubing 25 is installed, allowing for transportation of hydrocarbons from the subsurface formation 11 to the surface. A packer 15 is set near the lower end of the production tubing 25. This device seals the annular space between the production tubing 25 and the production casing 24, directing the flow of hydrocarbons through the production tubing 25.

A cement bond logging tool 30 is illustrated as being lowered into and suspended in the wellbore 10 by a wireline 41 that extends from the surface. Surface equipment 44 controls the lowering and raising action of the wireline 41. Incorporated within the surface equipment 44 is a communication device 45 that facilitates bidirectional communication between the surface equipment 44 and the cement bond logging tool 30. The communication device 45 transmits commands from the surface equipment 44 to the cement bond logging tool 30, and also receives data from the cement bond logging tool 30, via the wireline 41.

In addition to the communication device 45, the surface equipment 44 includes a data processing system 46. A power supply system 47 is housed within the surface equipment 44 to supply power to the surface equipment 44, and, dependent upon whether the cement bond logging tool 30 has a battery, may also transmit power down to the cement bond logging tool 30 via the wireline 41.

An operator interface, which may be a computer terminal, allows operators to send commands to the cement bond logging tool 30, visualize the data received from the data processing system 46, and monitor the overall operation, thereby providing control over the corrosion measurement process.

The illustrated cement bond logging tool 30 is designed to evaluate the quality of the bond between the casing and the surrounding cement. The cement bond logging tool 30 may be a Radial Bond Tool (RBT) and include a mechanical housing 31, which carries components including a controller 52, a transmitter 53 for generating and transmitting acoustic waves in response to the acoustic drive signal, a sector receiver array 54 (made up of multiple sectors arranged to each cover a different azimuthal sector) longitudinally spaced apart from the transmitter 53 by 3 ft, and a single receiver 55 longitudinally spaced apart from the transmitter 53 by 5 ft.

During operation to perform CBL measurements, the transmitter 53 transmits an acoustic wave at a frequency of 20 KHz that travels radially outward, passing through the casing strings (e.g., production casing 24), the adjacent cement 34, and the surrounding formation. As the acoustic wave interacts with the casing, cement, and surrounding formation, portions of the signal are reflected back and propagate toward the tool 30 due to differences in acoustic impedance between these materials, and are subsequently captured by the sector receiver array 54 from all around the tool during an acquisition window that is sufficiently long to permit the trainsets of the third interface echo to reach the sector receiver array 54.

The quality of the bond between the casing and the cement influences the amount of attenuation in the received acoustic signal. The amplitude of the E1 peak waveform, which is assumed to be the first arrival of the casing signal during the acquisition window, is of particular interest. In instances where the bond between the casing and cement is strong, the amplitude of this waveform is decreased, indicating that the cement, firmly adhered to the casing, has attenuated the signal. Conversely, in cases of weak bonding or the presence of a cement void, the E1 peak amplitude will be considerably higher as a result of little to no attenuation.

The controller 52 may control the transmitter 53 and receivers 54 and 55 to perform the cement bond logging and may transmit data via a communication system 51 to the communication device 45 at the surface. The data processing system 46 at the surface may be responsible for processing the data received from the tool 30. For instance, the data processing system 46 can generate cement bond logs from the received data, and subsequently visualize these measurements in a format comprehensible to an operator pursuant to the workflow described hereinbelow. As an alternative, the controller 52 may perform this functionality.

### C. Workflow Description

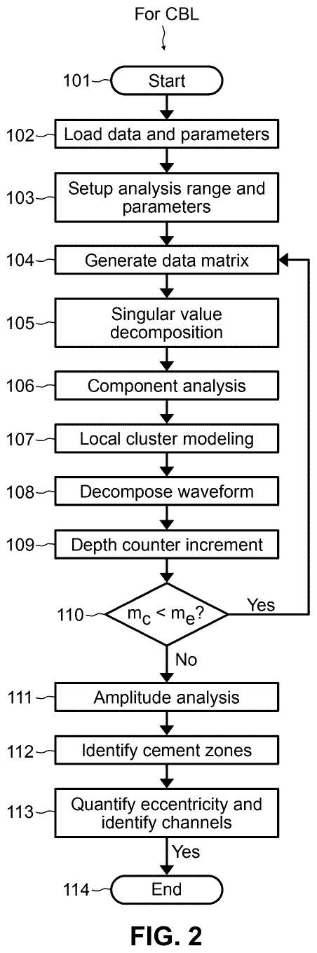

With additional reference to FIG. 2, the data analysis workflow for cement evaluation and casing eccentricity detection using sector CBL log data captured with an extended acquisition time window (e.g., on the order of seven hundred to eight hundred microseconds) is now described. Note that this workflow may be performed by the data processing system 46 described above or by the controller or processor 52 of the tool 30.

After the start (Block 101), data and parameters are loaded (Block 102). At this step 102, the sector CBL log data and the well environmental parameters are loaded. Here, sector CBL log data refers to the reflected sonic data captured by the receivers 54 or 55 of tool 30, and the well environmental parameters refer to the conditions within the wellbore and the formation and can influence the acquisition and interpretation of the logs, such as borehole size and geometry, mud properties, casing properties, cement properties, formation properties, etc.

Next, the analysis range and parameters are setup (Block 103). This is performed by selecting the depth point range [mₛ, mₑ] for analyzing local structure variances of the well, and by setting the depth counter m_{C} to m_{c}=mₛ.

Next, the data matrix Xₘ_{_{c}} is generated (Block 104), this data matrix being a matrix of waveform data (e.g., the CBL log data)—each row represents waveform data at different azimuthal sectors at the m_{C}th depth points. This is performed by, at each depth point specified by the depth counter m_{C}, generating a waveform data matrix Xₘ_{_{c}} to be used for multiple component analysis, which is a technique employed to dissect data sets into simpler, more interpretable patterns. This matrix encompasses the waveform data from each azimuthal sector. Mathematically, this is represented as:

$${X}_{{m}_{c}} = [ \begin{matrix}{x}_{{m}_{c , 1} ( {t}_{1} )} & … & {x}_{{m}_{c , 1} ( {t}_{{N}_{t}} )} \\ ⋮ & ⋱ & ⋮ \\ {x}_{{m}_{c , {N}_{s}} ( {t}_{1} )} & … & {x}_{{m}_{c , {N}_{s}} ( {t}_{{N}_{t}} )}\end{matrix} ] = [ \begin{matrix}{x}_{{m}_{C} , 1} \\ ⋮ \\ {x}_{{m}_{C} , {N}_{s}}\end{matrix} ]$$

where xₘ_{_{C}}_{,i}, i=1, 2, . . . , Nₛ is the waveform acquired at the ith azimuthal sector and the m_{C}th depth points.

Singular value decomposition is then performed on the data matrix Xₘ_{_{C}} to break it down into its constituent components (Block 105), which are called eigenvectors and eigenvalues. The eigenvectors represent directions in which the data varies the most, and the eigenvalues represent the magnitude of their corresponding eigenvectors. In particular, singular value decomposition transforms a complex matrix into three distinct matrices. Mathematically, this is represented as:

$${X}_{{m}_{C}} = {U}_{{m}_{C}} {S}_{{m}_{C}} {V}_{{m}_{C}}^{T}$$

T denotes a transpose operation, which flips the matrix over its diagonal, turning the matrix's rows into columns and vice versa.

The matrix Uₘ_{_{C}} is a left singular matrix with its columns containing the eigenvectors of Xₘ_{_{C}}Xₘ_{_{C}}^{T} which represents the covariance matrix of the original data matrix when it is treated as a set of vectors. The columns of Uₘ_{_{C}} (the eigenvectors) are orthogonal to each other and represent the directions in the data space where the data varies the most. Uₘ_{_{C}} is not necessarily square and may have the same number of rows as Xₘ_{_{C}}.

The matrix Vₘ_{_{C}} is a right singular matrix containing the right singular vectors, which are the eigenvectors of Xₘ_{_{C}}^{T}Xₘ_{_{C}}. This matrix represents the covariance of the transposed data matrix, and its eigenvectors are orthogonal directions that capture the most variance in the data. Mathematically speaking, Vₘ_{_{C}} is the matrix composed of the eigenvectors vₘ_{_{C}}_{,i}, i=1, 2, . . . , Nₛ, with Nₛ representing the total number of azimuthal sectors.

The matrix Sₘ_{_{C}} is a singular value matrix, and is a diagonal matrix, with all of its non-diagonal entries being zero and its diagonal entries being non-negative numbers known as singular values. These singular values are derived from the square roots of the eigenvalues of the matrix product Xₘ_{_{C}}Xₘ_{_{C}}^{T} and they are ordered in descending fashion from the top left to the bottom right of the matrix. The dimension of the matrix Sₘ_{_{C}} corresponds to the total number of azimuthal sectors. Mathematically, the matrix Sₘ_{_{C}} can be represented as:

$${S}_{{m}_{C}} = [ \begin{matrix}{σ}_{{m}_{C} , 1} & 0 & 0 & 0 \\ 0 & {σ}_{{m}_{C} , 2} & 0 & 0 \\ 0 & 0 & ⋱ & 0 \\ 0 & 0 & 0 & {σ}_{{m}_{C} , {N}_{s}}\end{matrix} ] ,$$

Here, σₘ_{_{C}}_{,1}, σₘ_{_{C}}_{,2}, . . . , σₘ_{_{C}}_{,N}_{ₛ} are the singular values, which are non-negative and ordered such that σₘ_{_{C}}_{,1}>σₘ_{_{C}}_{,2}> . . . >σₘ_{_{C}}_{,N}_{ₛ}, with Nₛ representing the total number of azimuthal sectors.

Component analysis is then performed (Block 106) to effectively filter out noise or extraneous information and identify the most significant components in the waveform data. In this step, the first set of r components that satisfy the condition

$$\frac{{σ}_{{m}_{C} , j}}{{σ}_{{m}_{C} , j + 1}} > ε$$

are then identified and selected. Here, σₘ_{_{C}}_{,j} and σₘ_{_{C}}_{,j+1} are σₘ_{_{C}}_{,j+1} consecutive singular values derived from the singular value decomposition process, and e is a predefined threshold. These r components provide insight into local cluster of waveforms, the local clusters representing specific depth points and their associated waveform patterns.

Local cluster modeling is then performed (Block 107) to construct a model for the waveforms at each depth point, representing each as a combination of independent components identified in the component analysis (Block 106). In greater detail, local cluster modeling is a technique that examines the waveforms at each depth point in the context of its surrounding data and expresses each depth point's waveform as a combination of independent components. In the given workflow therefore, the local cluster of waveforms Xₘ_{_{C}} at each m_{C}th depth point is modeled as a number rₘ_{_{C}} of independent components, with these components being those selected above in Block 106.

The model is mathematically formulated as:

$${X}_{{m}_{C}} = {A}_{{m}_{C}} {V}_{{m}_{C} , {r}_{{m}_{C}}}^{T}$$

### The Xₘ_{_{C}} and

$${V}_{{m}_{C} , {r}_{{m}_{C}}}^{T}$$

terms are known from Steps 104 and 105, while Aₘ_{_{C}} is the unknown term. Aₘ_{_{C}} is a matrix capturing the amplitude or strength of each component of the waveform for every azimuthal sector, quantifying how much each independent component contributes to the waveform observed at that particular depth and azimuthal sector. Mathematically, Aₘ_{_{C}} can be represented as:

$${A}_{{m}_{C}} = [ \begin{matrix}{a}_{1 , 1}^{{m}_{C}} & {a}_{1 , 2}^{{m}_{C}} & … & {a}_{1 , {r}_{{m}_{C}}}^{{m}_{C}} \\ {a}_{2 , 1}^{{m}_{C}} & {a}_{2 , 2}^{{m}_{C}} & … & {a}_{2 , {r}_{{m}_{C}}}^{{m}_{C}} \\ ⋮ & ⋮ & ⋱ & ⋮ \\ {a}_{{N}_{s} , 1}^{{m}_{C}} & {a}_{{N}_{s} , 2}^{{m}_{C}} & … & {a}_{{N}_{s} , {r}_{{m}_{C}}}^{{m}_{C}}\end{matrix} ] = [ \begin{matrix}{a}_{{m}_{C} , 1} \\ {a}_{{m}_{C} , 2} \\ ⋮ \\ {a}_{{m}_{C} , {N}_{s}}\end{matrix} ]$$

Following this, the modeled waveform \tilde{x}ₘ_{_{C}}_{,i} is obtained through decomposition (Block 108). This takes the local cluster model of the waveform Xₘ_{_{C}} and applies the model's components to reconstruct the waveform at each azimuthal sector. Using eigenvectors vₘ_{_{C}}_{,k}, where k=1, 2, . . . , rₘ_{_{C}}, the modeled waveform \tilde{x}ₘ_{_{C}}_{,i} at each azimuthal sector is assembled as a weighted sum of the significant components determined by the local cluster modeling. Each component is then weighted by its corresponding score a k from the matrix Aₘ_{_{C}}. Mathematically, this is represented as:

$${\hat{x}}_{{m}_{C} , i} = {a}_{{m}_{C} , i} {V}_{{m}_{C} , {r}_{{m}_{C}}}^{T} = {\sum }_{k = 1}^{{r}_{{m}_{C}}} {a}_{i , k}^{{m}_{C}} {v}_{{m}_{C} , k}^{T} = {\sum }_{k = 1}^{{r}_{{m}_{C}}} {x}_{{m}_{C} , i , k}$$

In simpler terms, this equation states that the waveform at a given depth and azimuthal sector is a combination of its constituent components, each scaled by its significance or amplitude.

Once the waveform is decomposed, the least squared error method is then used to calculate the scores aₘ_{_{C}}_{,i} of the identified significant components so that it closely represents the original waveform data. Mathematically, this is represented as follows:

$${a}_{{m}_{C} , i} = {x}_{{m}_{C} , i} {V}_{{m}_{C} , {r}_{{m}_{C}}}$$

The depth counter m_{C} is then incremented (Block 109). If the depth counter m_{C} is less than mₑ, the workflow reverts to Block 104, but otherwise, the workflow proceeds to Block 111—the workflow therefore loops through all depth points of interest prior to proceeding to Block 111.

At Block 111, amplitude analysis is performed. Here, the amplitudes of the E1 peaks are identified from the modeled waveform \tilde{x}ₘ_{_{C}}_{,i} at the m_{C}th depths and ith azimuthal sectors. As explained, the E1 peaks are in the first acoustic waves received by the sector sensors of the sector sensor array in the tool.

Cement zones are then identified (Block 112). Here, the amplitudes of the E1 peaks of the modeled waveform \tilde{x}ₘ_{_{C}}_{,i} at the m_{C}th depths are used to identify the top and bottom of the cement. Any region outside of these boundaries is a free pipe zone, indicating portions of the casing not in direct contact with cement. Also, regions with weak or absent E1 peaks indicate areas of good cement bonding, while strong peaks denote free pipe zones or regions of poor cement bonding.

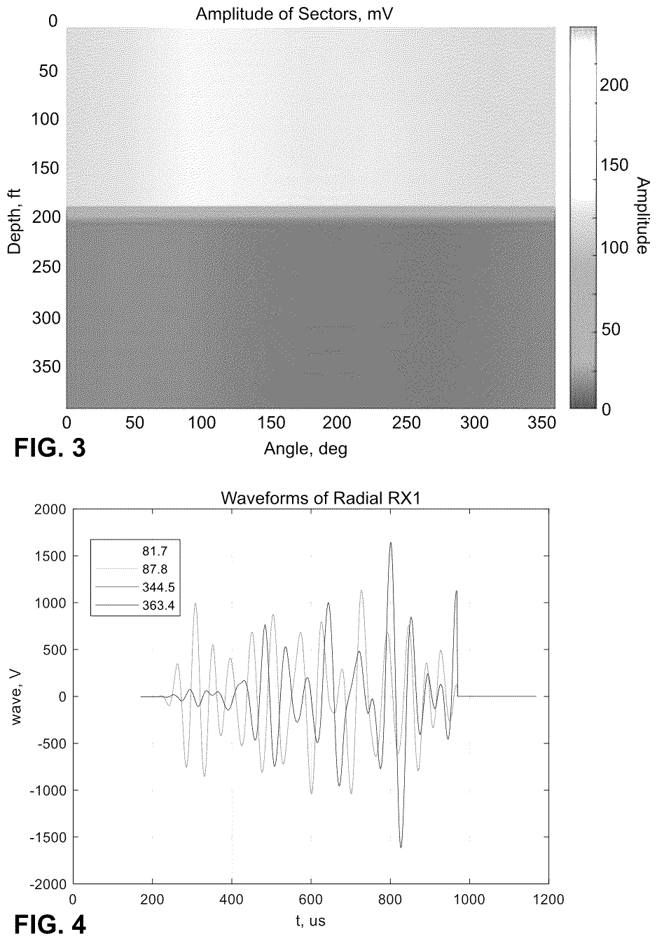

To illustrate how the workflow at this point may be utilized and visualized, shown in FIG. 3 is a graph of example data showing the E1 peak amplitudes of the modeled waveform \tilde{x}ₘ_{_{C}}_{,i} over a range of depths. The y-axis shows the depth, the x-axis shows azimuth, and the shading shows the amplitude of the waveform, with darker shading indicating a lower amplitude than lighter shading. In this graph, it can be clearly seen that the E1 peak amplitude of the sample modeled waveform is substantially lower below about 200 ft than above that depth and that there is a clear, sharp demarcation of the change in amplitude at that depth. The low amplitude below 200 ft is indicative of a good cement bond, as the cement attenuates the sonic waves passing therethrough, while the high amplitude above 200 ft is indicative of a lack of cement above that depth. From this therefore, the cement top in this example can be determined to be at the 200 ft mark, and above the 200 ft mark in this example is a free pipe zone.

Shown in FIG. 4 is a graph showing the raw waveform data over time at four different depths (81.7 ft, 87.8 ft, 344.5 ft, and 363.4 ft) for one azimuthal sector (that covered by a first sector of the sector receiver array 54 of the above described RBT tool 30, for example). Consistent with the discussion of FIG. 3, at depths above 200 ft, which here are the 81.7 and 87.8 ft samples, the amplitude is initially high (e.g., the amplitude of the E1 peak is high). Also consistent with the discussion of FIG. 3, at depths below 200 ft, which here are the 344.5 ft and 363.4 ft samples, the amplitude is initially low (e.g., the amplitude of the E1 peak is low).

Continuing with the workflow, eccentricity represents the deviation of the casing from its ideal, centered position within the wellbore. An eccentricity index of the casing is calculated at each depth (Block 113) as:

$${e}_{{m}_{C} , i} = \frac{{a}_{i , 2}^{{m}_{C}}}{{a}_{i , 1}^{{m}_{C}}}$$

This equation takes into account the amplitude weights of the waveform components, providing a measure of the standoff of the casing might be at each depth. Therefore, eccentricity is identified and quantified at Block 113.

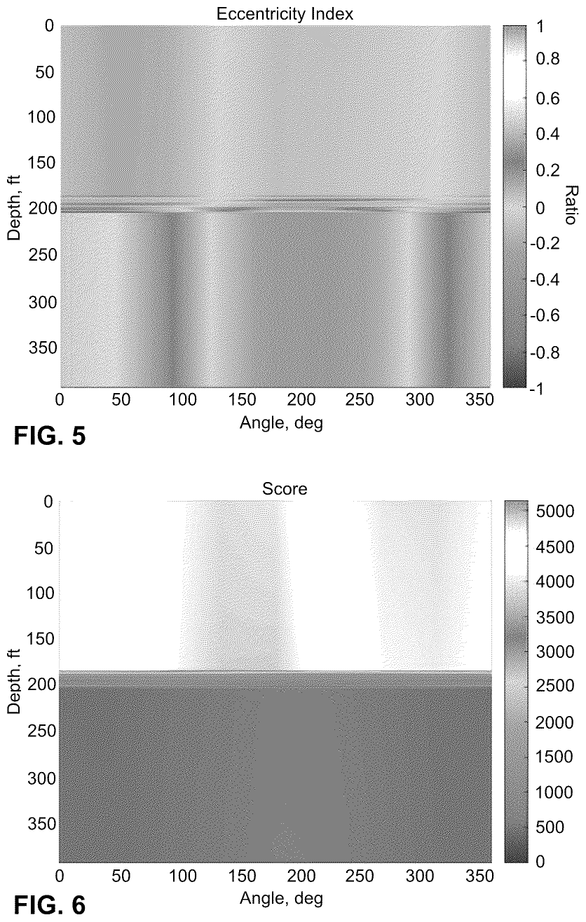

Continuing with the illustration of how the workflow may be utilized and visualized, a graph of the eccentricity index of the example data is shown in FIG. 5. Here, observe the relatively higher eccentricity index around 200 and the relatively lower eccentricity index around 200°, indicative of the fact that the casing in this example is not centered within the wellbore.

This eccentricity can be further observed in the graph of FIG. 6, showing a sample weight or score of component-1 of waveforms xₘ_{_{C}}_{,i} over a range of depths. Observe that above 200 ft, the score of component-1 of waveforms is lower between 270° and 350° than outside of this azimuthal range, which is further indicative of the eccentricity of the casing in this example where the casing wall is not parallel with formation wall.

Channels or voids within the cement can compromise the structural integrity of the well. Therefore, next, for intervals bounded by cement, the presence of cement channels is detected using the weight or score a_{i,1}^{m}^{_{C}} of the first component of the modeled waveform \tilde{x}ₘ_{_{C}}_{,i} at the m_{C}th depth and ith sector to detect potential cement channels (Block 113). A significant deviation in this score may indicate the presence of these channels, signaling the desire for further evaluation or remedial action.

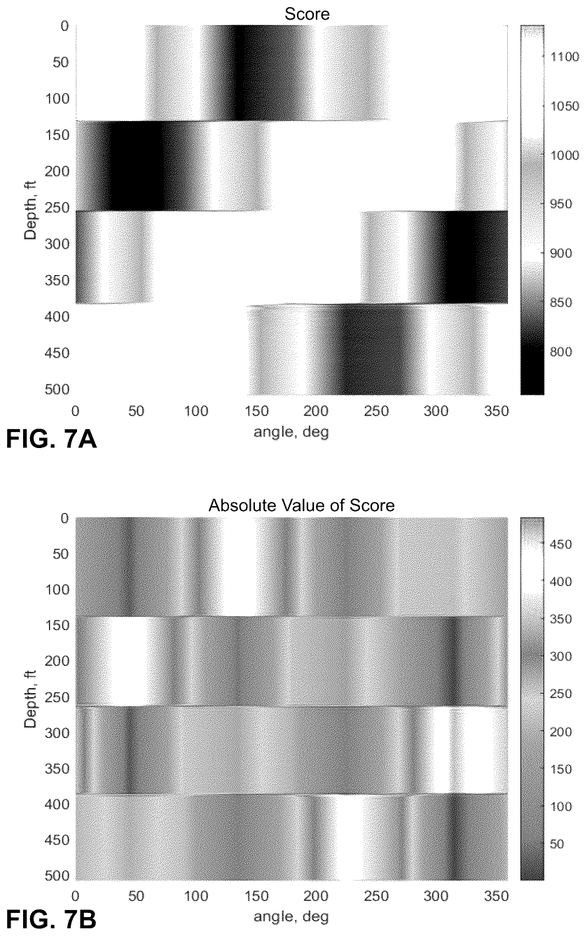

To show the visualization of data from the workflow to perform channel identification, refer to FIG. 7A, showing a sample score a_{i,1}^{m}^{_{C}} of component-1 of waveforms xₘ_{_{C}}_{,i} over a range of depths. When reviewing this visualization, understand that, optionally, when operating the tool 30 to identify channels or voids, the tool 30 may be rotated to different positions for logging different depth ranges. In the example of FIG. 7A, to log between 0 ft and 500 ft, the tool 30 has been rotated by 90° at a depth of around 125 ft, at a depth of around 250 ft, and at a depth of around 375 ft.

Observe, for example, that in the range between 0 ft and 125 ft, the score is much higher between 250° and 360° and between 0° and 50° than between 50° and 250°. Observe that with the 900 rotation of the tool at the depth of 125 ft, the region of high amplitude moves to between 160° and 320°, with the further 900 rotation of the tool at the depth of 250 ft, the region of high amplitude moves to between 70° and 230°, and with the final 900 rotation of the tool at the depth of 375 ft, the region of high amplitude moves to between 0° and 1400 and between 340° and 360°. The movement in the visualization of the band of high amplitude with tool rotation is indicative of the identification of a cement channel.

Continuing with this example, refer to FIG. 7B, showing a sample weight or score of component-2 of waveforms aₘ_{_{C}}_{,2} over a range of depths. In the example of FIG. 7A, as with FIG. 7B, to log between 0 ft and 500 ft, the tool 30 has been rotated by 90° at a depth of around 125 ft, at a depth of around 250 ft, and at a depth of around 375 ft.

In the range between 0 ft and 125 ft, the absolute score is much higher between 1000 and 1600 than between 0° and 1000 or between 160° and 360°. With the 900 rotation of the tool at the depth of 125 ft, the region of high absolute score moves to between 0° and 75°. With the further 900 rotation of the tool at the depth of 250 ft, the region of high absolute score moves to between 275° and 360°, and with the final 90° rotation of the tool at the depth of 375 ft, the region of high absolute score moves to between 200° and 275°. As explained, the movement in the visualization of the band of high absolute score with tool rotation is indicative of the identification of a cement channel, with the regions of high absolute score (the light regions) being representative of the cement channels.

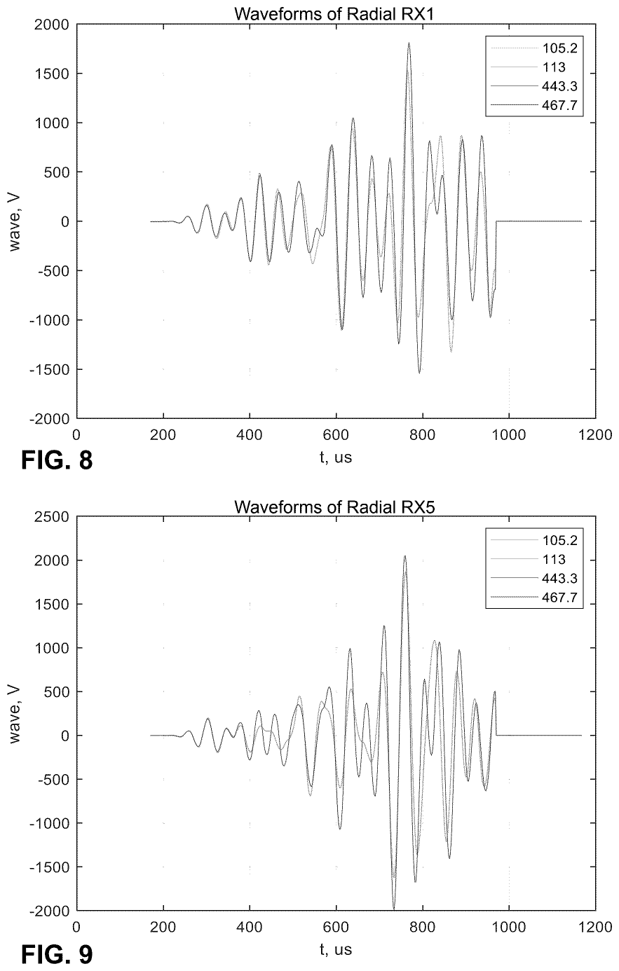

As further visualization, refer to FIG. 8, showing the raw waveform data over time at four different depths (105.2 ft, 113 ft, 443.3 ft, and 467.7 ft) for the first azimuthal sector (that covered by a first sector of the sector sensor array 55 of the above described RBT tool 30) and FIG. 9, showing the raw waveform data for the example data over time at the four different depths for the fifth azimuthal sector (that covered by a fifth sector of the sector sensor array 55 of the above described RBT tool 30). These waveforms provide insights about the casing, cement, and formation.

This completes the workflow for cement evaluation and casing eccentricity detection using sector CBL log data (Block 114).

By interpreting the sector CBL logs using the above-described workflows, operators are better equipped to make informed decisions about the integrity and quality of the cement surrounding the casing. Recognizing areas with poor cement bonding is of particular interest, as it highlights the need for interventions, such as a secondary cement job (e.g., a squeeze job). Areas of high eccentricity do not just flag potential wellbore instability or flawed cement placement, as they also offer insights into how the cement might be positioned outside the casing. Elevated eccentricity may be a sign of an inadequate cement job, pointing to concerns like compromised zonal isolation, potential water contamination, or more extensive well integrity issues. Beyond indicating the need for remedial actions such as a secondary cement job, eccentricity data plays a strategic role. Specifically, zones with pronounced eccentricity may be marked as unsuitable for pipe cutting, as cutting in these areas could hinder the pipe from being properly dislodged. In sum, the insights derived from both workflows furnish operators with the knowledge of the need to take necessary remedial actions, increasing well safety, enhancing performance, and providing for additional longevity.

It is evident that modifications and variations can be made to what has been described and illustrated herein without departing from the scope of this disclosure.

Although this disclosure has been described with a limited number of embodiments, those skilled in the at, having the benefit of this disclosure, can envision other embodiments that do not deviate from the disclosed scope. Furthermore, skilled persons can envision embodiments that represent various combinations of the embodiments disclosed herein made in various ways.

1. A method for evaluating cement between a casing string in a wellbore and material surrounding the casing string, and for detecting eccentricity of the casing string, using sector cement bond log (CBL) data, the method comprising steps of:
a) using a cement bond logging tool to capture sector CBL data with an extended acquisition time window, the extended acquisition time window being sufficiently long to permit logging of multiple interface echoes, each interface echo indicating an acoustic reflection generated when an acoustic wave emitted by the cement bond logging tool encounters an interface between different materials;
b) setting a depth range and initializing a depth counter;
c) from the sector CBL data, generating a data matrix of waveform data from the sector CBL data at the depth specified by the depth counter, where each row of the data matrix represents waveform data collected by the cement bond logging tool from different azimuthal sectors;
d) performing singular value decomposition on the data matrix to derive its constituent components;
e) conducting component analysis to filter out noise and identify significant waveform components;
f) generating a local cluster model of the waveform data at the depth specified by the depth counter as a combination of the identified significant components, using local cluster modeling;
g) applying the local cluster model to the waveform data, thereby producing a modeled waveform represented as a combination of its identified significant components;
h) if the depth counter is less than an end of the depth range, increment the depth counter and return to step c), otherwise proceed to step i);
i) identifying cement zones based on amplitudes of first E1 peaks of modeled waveforms for each azimuthal sector;
j) calculating an eccentricity index, for each sector, representing deviation of the casing string from its ideal position; and
k) detecting cement channels based on deviations in a first component of the modeled waveform at each depth and azimuthal sector.

2. The method of claim 1, further comprising from the cement zones, identifying free pipe zones, wherein the free pipe zones are depth zones in which cement is not present about the casing string.

3. The method of claim 2, wherein the eccentricity index is calculated for each depth point.

4. The method of claim 1, wherein the extended acquisition time window has a time duration of between 700 μs and 800 μs.

5. The method of claim 1, wherein the extended acquisition time window is sufficiently long to permit logging of first, second, and third interface echoes, the first interface echo being between the cement bond logging tool and the casing, the second interface echo being between the casing and the cement, the third interface echo being between casing annulus filling material and a formation into which the wellbore is drilled.

6. The method of claim 1, wherein the data matrix is:
$${X}_{{m}_{c}} = [ \begin{matrix}{x}_{{m}_{c , 1} ( {t}_{1} )} & … & {x}_{{m}_{c , 1} ( {t}_{{N}_{t}} )} \\ ⋮ & ⋱ & ⋮ \\ {x}_{{m}_{c , {N}_{s}} ( {t}_{1} )} & … & {x}_{{m}_{c , {N}_{s}} ( {t}_{{N}_{t}} )}\end{matrix} ] = [ \begin{matrix}{x}_{{m}_{C} , 1} \\ ⋮ \\ {x}_{{m}_{C} , {N}_{s}}\end{matrix} ]$$
wherein x_{c,i}, i=1, 2, . . . , Nₛ is the waveform data acquired by the cement bond logging tool at ith azimuthal sector and a m_{C}th depth point, wherein the depth range is [mₛ, mₑ], and wherein the depth counter is initialized to m_{C}=mₛ.

7. The method of claim 6, wherein the singular value decomposition is performed as:
$${X}_{{m}_{C}} = {U}_{{m}_{C}} {S}_{{m}_{C}} {V}_{{m}_{C}}^{T}$$
where T denotes a transpose operation,
where Uₘ_{_{C}} is a left singular matrix containing eigenvectors of Xₘ_{_{C}}Xₘ_{_{C}}^{T},
where Vₘ_{_{C}} is a right singular matrix containing eigenvectors of Xₘ_{_{C}}^{T}Xₘ_{_{C}},
where Sₘ_{_{C}} is a singular value diagonal matrix, with its values being derived from the eigenvalues of Xₘ_{_{C}}Xₘ_{_{C}}^{T}, with Sₘ_{_{C}} being
$${S}_{{m}_{C}} = [ \begin{matrix}{σ}_{{m}_{C} , 1} & 0 & 0 & 0 \\ 0 & {σ}_{{m}_{C} , 2} & 0 & 0 \\ 0 & 0 & ⋱ & 0 \\ 0 & 0 & 0 & {σ}_{{m}_{C} , {N}_{s}}\end{matrix} ] ,$$
where σₘ_{_{C}}_{,1}>σₘ_{_{C}}_{,2}> . . . >σₘ_{_{C}}_{,N}_{ₛ}
where σₘ_{_{C}}_{,1}, σₘ_{_{C}}_{,2}, . . . , σₘ_{_{C}}_{,N}_{ₛ} are the singular values of the singular value diagonal matrix, which are non-negative and ordered such that σₘ_{_{C}}_{,1}>σₘ_{_{C}}_{,2}> . . . >σₘ_{_{C}}_{,N}_{ₛ}, with Nₛ representing a total number of the azimuthal sectors.

8. The method of claim 7, wherein the identification of the significant waveform components is performed by identifying a set of r components that satisfy
$$\frac{{σ}_{{m}_{C} , j}}{{σ}_{{m}_{C} , j + 1}} > ε ,$$
with σₘ_{_{C}}_{,j} and σₘ_{_{C}}_{,j+1} being consecutive singular values derived from the singular value decomposition, and with E being a predefined threshold.

9. The method of claim 8, wherein the local cluster model of the waveform data generated at step f) is generated as:
$${X}_{{m}_{C}} = {A}_{{m}_{C}} {V}_{{m}_{C} , {r}_{{m}_{C}}}^{T}$$
where Aₘ_{_{C}} is a matrix capturing weight or score of each feature component vₘ_{_{C}}_{,k}^{T} of waveform for every azimuthal sector, represented as:
$${A}_{{m}_{C}} = [ \begin{matrix}{a}_{1 , 1}^{{m}_{C}} & {a}_{1 , 2}^{{m}_{C}} & … & {a}_{1 , {r}_{{m}_{C}}}^{{m}_{C}} \\ {a}_{2 , 1}^{{m}_{C}} & {a}_{2 , 2}^{{m}_{C}} & … & {a}_{2 , {r}_{{m}_{C}}}^{{m}_{C}} \\ ⋮ & ⋮ & ⋱ & ⋮ \\ {a}_{{N}_{s} , 1}^{{m}_{C}} & {a}_{{N}_{s} , 2}^{{m}_{C}} & … & {a}_{{N}_{s} , {r}_{{m}_{C}}}^{{m}_{C}}\end{matrix} ] = [ \begin{matrix}{a}_{{m}_{C} , 1} \\ {a}_{{m}_{C} , 2} \\ ⋮ \\ {a}_{{m}_{C} , {N}_{s}}\end{matrix} ]$$
with each value a_{i,j}^{m}^{_{C}} quantifying contribution of a jth independent component from the set of r components to the waveform data at the ith azimuthal sector at the depth point m_{C}
and with aₘ_{_{C}}_{,i} being a row vector representing scores of independent components contributed to the waveform for the ith azimuthal sector at the depth point m_{C}.

10. The method of claim 9, wherein the application of the local cluster model to the waveform data at step g) is performed as a decomposition represented by:
$${\hat{x}}_{{m}_{C} , i} = {a}_{{m}_{C} , i} {V}_{{m}_{C} , {r}_{{m}_{C}}}^{T} = {\sum }_{k = 1}^{{r}_{{m}_{C}}} {a}_{i , k}^{{m}_{C}} {v}_{{m}_{C} , k}^{T} = {\sum }_{k = 1}^{{r}_{{m}_{C}}} {x}_{{m}_{C} , i , k}$$
with a least squared error method then being used to calculate each row vector as:
$${a}_{{m}_{C} , i} = {x}_{{m}_{C} , i} {V}_{{m}_{C , {r}_{{m}_{C}}}} .$$

11. The method of claim 10, wherein the eccentricity index is calculated at each depth, only if a second feature component of the waveform of the ith sector is associated with the casing eccentricity, as:
$${e}_{{m}_{C} , i} = \frac{{a}_{i , 2}^{{m}_{C}}}{{a}_{i , 1}^{{m}_{C}}} .$$

12. A system for evaluating cement between a casing string in a wellbore and formation, and for detecting eccentricity of the casing string, the system comprising
a cement bond logging tool configured to capture sector CBL data with an extended acquisition time window, the extended acquisition time window being sufficiently long to permit logging of multiple interface echoes, each interface echo indicating an acoustic reflection generated when an acoustic wave emitted by the cement bond logging tool encounters an interface between different materials;
processing circuitry associated with the cement bond logging tool and configured to perform steps of:
a) setting a depth range and initializing a depth counter;
b) from the sector CBL data, generating a data matrix of waveform data from the sector CBL data at the depth specified by the depth counter, where each row of the matrix represents waveform data collected by the cement bond logging tool from different azimuthal sectors;
c) performing singular value decomposition on the data matrix to derive its constituent components;
d) conducting component analysis to filter out noise and identify significant waveform components;
e) generating a local cluster model of the waveform data at the depth specified by the depth counter as a combination of the identified significant components, using local cluster modeling;
f) applying the local cluster model to the waveform data, thereby producing a modeled waveform represented as a combination of its identified significant components;
g) if the depth counter is less than an end of the depth range, increment the depth counter and return to step b), otherwise proceed to step h);
h) identifying cement zones based on amplitudes of first E1 peaks of modeled waveforms reflected by the interface between the casing string and the cement, for each azimuthal sector;
i) calculating an eccentricity index, for each sector, representing deviation of the casing string from its ideal position; and
j) detecting cement channels based on deviations in a first component of the modeled waveform at each depth and azimuthal sector.

13. The system of claim 12, wherein the processing circuitry comprises a controller within the cement bond logging tool.

14. The system of claim 12, wherein the processing circuitry comprises an uphole data processing system.

15. The system of claim 12, wherein the extended acquisition time window is sufficiently long to permit logging of first, second, and third interface echoes, the first interface echo being between the cement bond logging tool and the casing, the second interface echo being between the casing and the cement, the third interface echo being between casing annulus filling material and a formation into which the wellbore is drilled.

16. The system of claim 12, wherein the data matrix is:
$${X}_{{m}_{c}} = [ \begin{matrix}{x}_{{m}_{c , 1} ( {t}_{1} )} & … & {x}_{{m}_{c , 1} ( {t}_{{N}_{t}} )} \\ ⋮ & ⋱ & ⋮ \\ {x}_{{m}_{c , {N}_{s}} ( {t}_{1} )} & … & {x}_{{m}_{c , {N}_{s}} ( {t}_{{N}_{t}} )}\end{matrix} ] = [ \begin{matrix}{x}_{{m}_{C} , 1} \\ ⋮ \\ {x}_{{m}_{C} , {N}_{s}}\end{matrix} ]$$
wherein x_{c,i}, i=1, 2, . . . , Nₛ is the waveform data acquired by the cement bond logging tool at ith azimuthal sector and a m_{C}th depth point, wherein the depth range is [mₛ, mₑ], and wherein the depth counter is initialized to m_{C}=mₛ.

17. The system of claim 16, wherein the singular value decomposition is performed by the processing circuitry as:
$${X}_{{m}_{C}} = {U}_{{m}_{C}} {S}_{{m}_{C}} {V}_{{m}_{C}}^{T}$$
where T denotes a transpose operation,
where Uₘ_{_{C}} is a left singular matrix containing eigenvectors of Xₘ_{_{C}}Xₘ_{_{C}},
where Vₘ_{_{C}} is a right singular matrix containing eigenvectors of Xₘ_{_{C}}^{T}Xₘ_{_{C}},
where Sₘ_{_{C}} is a singular value diagonal matrix, with its values being derived from the eigenvalues of Xₘ_{_{C}} Xₘ_{_{C}}^{T}, with Sₘ_{_{C}} being
$${S}_{{m}_{C}} = [ \begin{matrix}{σ}_{{m}_{C} , 1} & 0 & 0 & 0 \\ 0 & {σ}_{{m}_{C} , 2} & 0 & 0 \\ 0 & 0 & ⋱ & 0 \\ 0 & 0 & 0 & {σ}_{{m}_{C} , {N}_{s}}\end{matrix} ] ,$$
where σₘ_{_{C}}_{,1}, σₘ_{_{C}}_{,2}> . . . >σₘ_{_{C}}_{,N}_{ₛ}
where σₘ_{_{C}}_{,1}, σₘ_{_{C}}_{,2}, . . . , σₘ_{_{C}}_{,N}_{ₛ} are the singular values of the singular value diagonal matrix, which are non-negative and ordered such that σₘ_{_{C}}_{,1}>σₘ_{_{C}}_{,2}> . . . >σₘ_{_{C}}_{,N}_{ₛ}, with Nₛ representing a total number of the azimuthal sectors.

18. The system of claim 17, wherein the identification of the significant waveform components is performed by the processing circuitry as identifying a set of r components that satisfy
$$\frac{{σ}_{{m}_{C} , j}}{{σ}_{{m}_{C} , j + 1}} > ε ,$$
with σₘ_{_{C}}_{,j} and σₘ_{_{C}}_{,j+1} being consecutive singular values derived from the singular value decomposition, and with E being a predefined threshold.

19. The system of claim 18, wherein the local cluster model of the waveform data generated by the processing circuitry at step e) is generated as:
$${X}_{{m}_{C}} = {A}_{{m}_{C}} {V}_{{m}_{C} , {r}_{{m}_{C}}}^{T}$$
where Aₘ_{_{C}} is a matrix capturing weight or score of each feature component vₘ_{_{C}}_{,k}^{T} of waveform for every azimuthal sector, represented as:
$${A}_{{m}_{C}} = [ \begin{matrix}{a}_{1 , 1}^{{m}_{C}} & {a}_{1 , 2}^{{m}_{C}} & … & {a}_{1 , {r}_{{m}_{C}}}^{{m}_{C}} \\ {a}_{2 , 1}^{{m}_{C}} & {a}_{2 , 2}^{{m}_{C}} & … & {a}_{2 , {r}_{{m}_{C}}}^{{m}_{C}} \\ ⋮ & ⋮ & ⋱ & ⋮ \\ {a}_{{N}_{s} , 1}^{{m}_{C}} & {a}_{{N}_{s} , 2}^{{m}_{C}} & … & {a}_{{N}_{s} , {r}_{{m}_{C}}}^{{m}_{C}}\end{matrix} ] = [ \begin{matrix}{a}_{{m}_{C} , 1} \\ {a}_{{m}_{C} , 2} \\ ⋮ \\ {a}_{{m}_{C} , {N}_{s}}\end{matrix} ]$$
with each value a_{i,j}^{m}^{_{C}} quantifying contribution of a jth independent component from the set of r components to the waveform data at the ith azimuthal sector at the depth point m_{C}
and with aₘ_{_{C}}_{,i} being a row vector representing scores of independent components to waveform for the ith azimuthal sector at the depth point m_{C}.

20. The system of claim 19, wherein the application of the local cluster model to the waveform data by the processing circuitry at step f) is performed as a decomposition represented by:
$${\hat{x}}_{{m}_{C} , i} = {a}_{{m}_{C} , i} {V}_{{m}_{C} , {r}_{{m}_{C}}}^{T} = {\sum }_{k = 1}^{{r}_{{m}_{C}}} {a}_{i , k}^{{m}_{C}} {v}_{{m}_{C} , k}^{T} = {\sum }_{k = 1}^{{r}_{{m}_{C}}} {x}_{{m}_{C} , i , k}$$
with a least squared error method then being used to calculate each row vector as:
$${a}_{{m}_{C} , i} = {x}_{{m}_{C} , i} {V}_{{m}_{C , {r}_{{m}_{C}}}}$$
wherein the eccentricity index is calculated at each depth as:
$${e}_{{m}_{C} , i} = \frac{{a}_{i , 2}^{{m}_{C}}}{{a}_{i , 1}^{{m}_{C}}} .$$
